(19) United States
(12) Patent Application Publication
(10) Pub. No.: US 2008/0133634 A1
(43) Pub. Date: Jun. 5, 2008

(54) 0.75-POWER COMPUTING APPARATUS AND METHOD

(76) Inventors: Suneetha Kalahasthi, Suwon-si (KR); Young-Hun Joo, Yongin-si (KR); Kwang-Pyo Choi, Anyang-si (KR); Han-Sang Kim, Suwon-si (KR)

Correspondence Address: CHA & REITER, LLC, 210 ROUTE 4 EAST STE 103, PARAMUS, NJ, 07652, US

(21) Appl. No.: 11/946,919

(22) Filed: Nov. 29, 2007

(30) Foreign Application Priority Data
Dec. 1, 2006 (KR) 120668/2006

(51) Int. Cl. G06F 7/552

(52) U.S. Cl. 708/606

(57) ABSTRACT

A 0.75-power computation apparatus and method are provided in which the range of an input value X is divided into a predetermined number areas, a 0.75 power of the input value X is represented as a predetermined approximation polynomial, coefficients for the approximation polynomial representing the input value X are preset for each of the areas, predetermined coefficients of the approximation polynomial are checked according to an actual input value X, and a 0.75-power of the actual input value X is computed using the approximation polynomial.

### CLAIM OF PRIORITY

This application claims the benefit of the earlier filing date, under 35 U.S.C. § 119(a), to that patent application filed in the Korean Intellectual Property Office on Dec. 1, 2006 and assigned Serial No. 2006-120668, the entire disclosure of which is hereby incorporated by reference.

### BACKGROUND OF THE INVENTION

1. Field of the Invention

The present invention generally relates to audio signal quantization. More particularly, the present invention relates to a 0.75-power computing technique for use in audio signal quantization.

2. Description of the Related Art

Audio coding performance has been improved with the introduction of quantization to audio coding. For the audio coding, quantization occurs a number of times, and incorporates a large number of arithmetic operations, especially 0.75-power computations. The 0.75-power computations impose significant load on Digital Signal Processors (DSPs) without units (logical or arthimetic) that calculate square roots/inverse square roots and reciprocals (i.e., fixed-point DSPs).

A block diagram of a typical audio encoder is illustrated in FIG. 6. Referring to FIG. 6, a filter bank E1 converts an input audio signal by a Modified Discrete Cosine Transform (MDCT), for example. To satisfy both bit rate and masking requirements, a pseudo acoustic model E2 analyzes masking characteristics by copying acoustic characteristics for the input audio signal and a quantizer E3 quantizes the converted signal using the masking characteristics. A bit stream formatter E4 formats the bit stream.

Because quantization is the subject matter of the present invention, a description of other function blocks will not be provided herein. In Moving Picture Expert Group (MPEG)-1 Layer III (MP3), the quantizer E3 quantizes the converted signal X, received from the filter bank E1, by a quantization precision 2^{qs} acquired from the psuedo acoustic model E2 by

IX=NINT((ABS(X)×2^{qs})^{0.75}−0.0946) (1)
where IX denotes the quantized value of X, ABS(Y) denotes the absolute value of Y, and NINT(Y) denotes an integer value closest to Y.

According to Equation (1), ABS(X) is calculated for the converted signal X from the filter bank E1 and then multiplied this value by 2^{qs}. The 0.75 power of the resulting product, i.e. (ABS(X)×2^{qs})^{0.75} is obtained.

The quantizer E3 adjusts a quantization step size (qs) until predetermined bit rate and quantization nose requirements are met. Consequently, computation of Equation (1) is carried out a multiple number of times by performing a large number of arithmetic operations. To reduce the number of arithmetic operations, Equation (1) is generally simplified to Equation (2).

IX=NINT((ABS(X)^{0.75}×2^{(qs×0.75)})−0.0946) (2)

In Equation (2), the 0.75 powers of ABS(X) and 2^{qs} are separately computed and the results are added to −0.0946. Since ABS(X)^{0.75} is calculated once and 2^{(qs×0.75)} is calculated for each quantization step size, Equation (2) is computationally simpler However, due to the 0.75-power calculation, i.e. ABS(X)^{0.75}, Equation (2) also requires a large number of arithmetic operations.

### SUMMARY OF THE INVENTION

An aspect of exemplary embodiments of the present invention is to address at least the problems and/or disadvantages described above. Accordingly, an aspect of exemplary embodiments of the present invention is to provide a method for enabling efficient 0.75-power computation in a DSP, especially a DSP without computation units that compute square roots/inverse square roots and reciprocals.

Moreover, an aspect of exemplary embodiments of the present invention provides an efficient 0.75-power computing method for use in quantization in audio coding.

In accordance with an aspect of exemplary embodiments of the present invention, there is provided a 0.75-power computation method in which the range of input value X is divided into a predetermined number areas or regions, a 0.75 power of the input value X is represented as a predetermined approximation polynomial, coefficients for the approximation polynomial representing the input value X are preset for each of the areas, predetermined coefficients of the approximation polynomial are checked according to an actual input value X, and a 0.75-power of the actual input value X is computed using the approximation polynomial.

In accordance with another aspect of exemplary embodiments of the present invention, there is provided a 0.75-power computation apparatus for dividing the range of input value X into a predetermined number areas, representing a 0.75 power of the input value X as a 3^{rd}-order polynomial being one of A×X³+B×X²+C×X+D and (((A×X+B)×X)+C)×X+D, and pre-storing coefficients for the approximation polynomial representing the input value X for each of the areas, in which a first multiplier multiplies a coefficient A determined according to the input value X by the input value X and outputs a first product, a first adder adds a coefficient B given according to the input value X to the first product and outputs a first sum, a second multiplier multiplies the first sum by the input signal X and outputs a second product, a second adder adds a coefficient C given according to the input signal X by the second product and outputs a second sum, a third multiplier multiplies the second sum by the input signal X and outputting a third product, and a third adder adds a coefficient D given according to the input signal X to the third product.

### BRIEF DESCRIPTION OF THE DRAWINGS

The above features and advantages of certain exemplary embodiments of the present invention will be more apparent from the following detailed description taken in conjunction with the accompanying drawings, in which:

FIG. 1 is a block diagram of a 0.75-power computing apparatus according to an exemplary embodiment of the present invention;

FIG. 2 is a flowchart illustrating a 0.75-power computation operation according to an exemplary embodiment of the present invention;

FIG. 3 is a block diagram of a 0.75-power computing apparatus using Newton's repetition for comparison with the present invention;

FIG. 4 is a flowchart illustrating a 0.75-power computation operation using Newton's repetition for comparison with the present invention;

FIG. 5 is a detailed flowchart illustrating step 21 illustrated in FIG. 4;

FIG. 6 is a block diagram of a typical audio encoder;

FIG. 7 is a graph illustrating numbers of arithmetic operations required for implementation of the present invention; and

FIG. 8 is a graph illustrating errors involved in 0.75-power computations according to the present invention.

Throughout the drawings, the same drawing reference numerals will be understood to refer to the same elements, features and structures.

### DETAILED DESCRIPTION OF THE INVENTION

The matters defined in the description such as a detailed construction and elements are provided to assist in a comprehensive understanding of exemplary embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The following description is largely divided into

1. 0.75-power computation by polynomial approximation according to the present invention; and

2. 0.75-power computation by Newton's approximation for comparison with the present invention.

1. 0.75-Power Computation by Polynomial Approximation

In accordance with the present invention, ABS(X)^{0.75} is simplified to X^{0.7} (ABS(X)^{0.75}=X^{0.7}) and a 3^{rd}-order polynomial is used for computing a 0.75 power. The range of an input signal X is 0.5≦x≦1, which is expressed in hexadecimal format (base 16) as, 0x40000000 to 0x7FFFFFFF in Q31. (Q-point arithmetic is a well-known technique in integer arithmetic calculations and need not be discussed in detail herein.). In the present invention, the range of the input signal X is divided into an appropriate number of areas, taking into account allowed errors, for example, 32 areas and coefficients of a polynomial representing X in each area are preset. For the 3^{rd}-order polynomial, four coefficients A, B, C and D shown in Equation (3) are preset for each area. Hence, the total number of coefficients to be stored is 128. Note that all of 128 coefficients are available and preset (in the event that the range of an input value X id divided into 64 areas, the value of 256 coefficients is preset), rather than set by a certain computing in real-time, by interpolation.

A×X³+B×X²+C×X+D (3)

Equation (3) with five multiplications and three additions is simplified to Equation (4) with fewer multiplications.

(((A×X+B)×X)+C)×X+D (4)

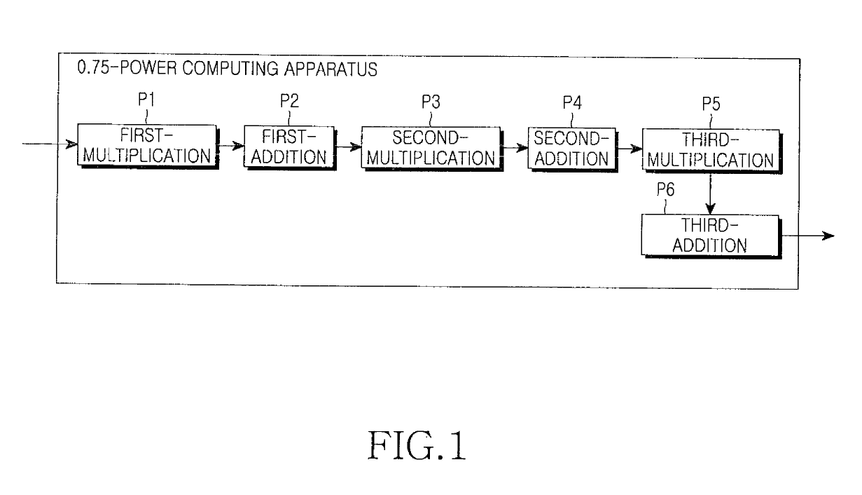

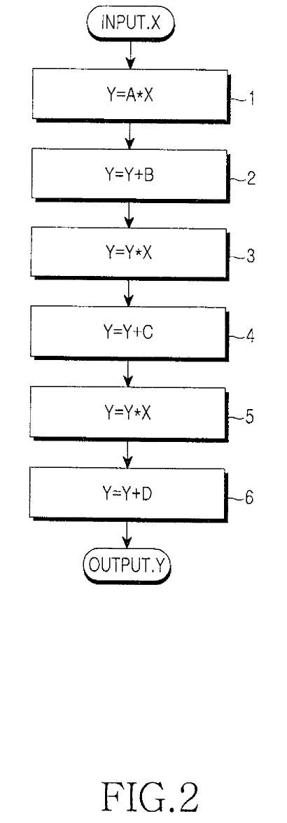

Equation (4) requires three multiplications and three additions. An apparatus and method for computing a 0.75 power by polynomial approximation according to the present invention are illustrated in FIGS. 1 and 2, respectively.

Referring to FIGS. 1 and 2, the 0.75-power computing apparatus includes a first multiplier P1 for multiplying a coefficient A determined according to the range of an input signal X by the input signal X (step 1), a first adder P2 for adding a coefficient B to the product received from the first multiplier P1 (step 2), a second multiplier P3 for multiplying the sum received from the first adder P2 by the input signal X (step 3), a second adder P4 for adding a coefficient C to the product received from the second multiplier P3 (step 4), a third multiplier P5 for multiplying the sum received from the second adder P4 by the input signal X (step 5), and a third adder P6 for adding a coefficient D to the product received from the third multiplier P5 (step 6).

In real system computation, the coefficients A, B, C and D are predetermined. For example, for X=0.5, A, B, C and D can be preset to 0.088, −0.332, 1.155, and 0.089, respectively. Note that the 0.75 power of X is “1”. A maximum error introduced to the 0.75-power computation is 2 Least Significant Bits (LSBs) of 32 bits in the present invention. A pseudo code for this algorithm is given as follows.
LOAD A, B, C, D

Y=A×X

Y=Y+B

Y=Y×X

Y=Y+C

Y=Y+D

The number of cycles for multiplication, addition, shift, and loading is different for each DSP. Assuming that a DSP needs two cycles for multiplication, one cycle for addition, one cycle for shifting, and one cycle for loading, the total number of cycles taken for 0.75-power computation by polynomial approximation according to the present invention is determined to be 13 (i.e., 3×2+3+4).

If loading is supported in parallel to multiplication, loading of the coefficients B, C and D can take place in parallel to the operations of the first, second and third multipliers P1, P3 and P5. Thus, the pseudo code is given as
LOAD A

Y=A×X∥LOAD B

Y=Y+B

Y=Y×X∥LOAD C

Y=Y+C

Y=Y×X∥LOAD D

Y=Y+D

Then, a total of 10 cycles are taken (i.e., 3×2+3+1).

2. 0.75-Power Computation by Newton's Approximation

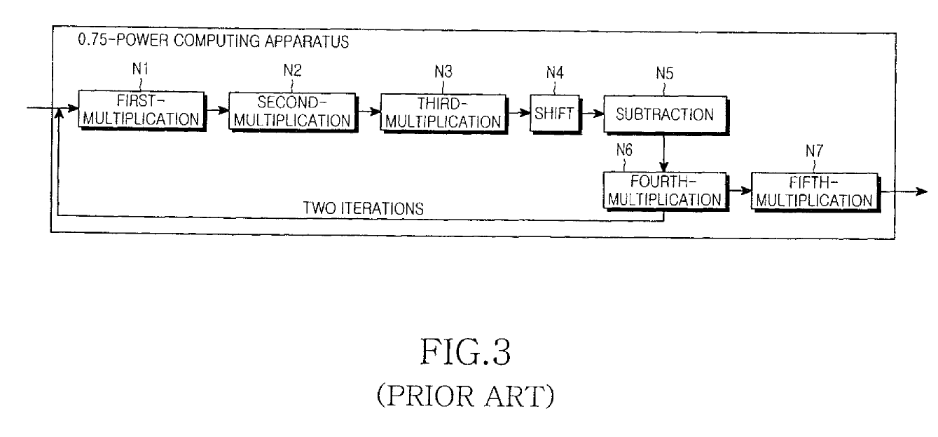

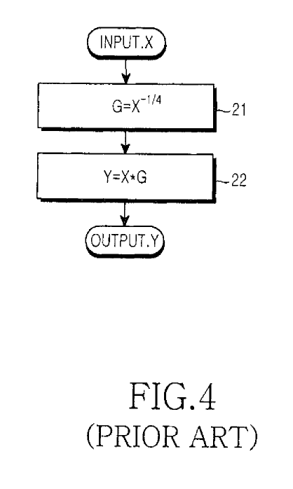

For comparison with the present invention, 0.75-power computation by Newton's approximation is shown in FIGS. 3, 4 and 5. This 0.75-power computation is expressed as

X^{0.75}=X×X^{-0.25} (5)

In Equation (5), X^{-0.25} is computed by Newton's repetition and then multiplied by X, thus producing a final output X^{0.75}.

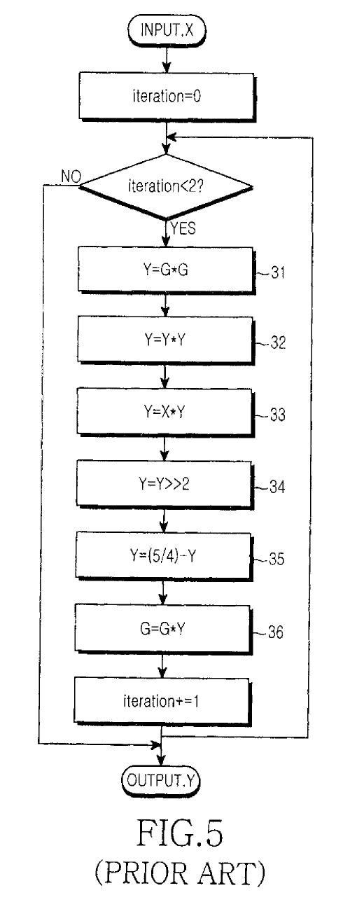

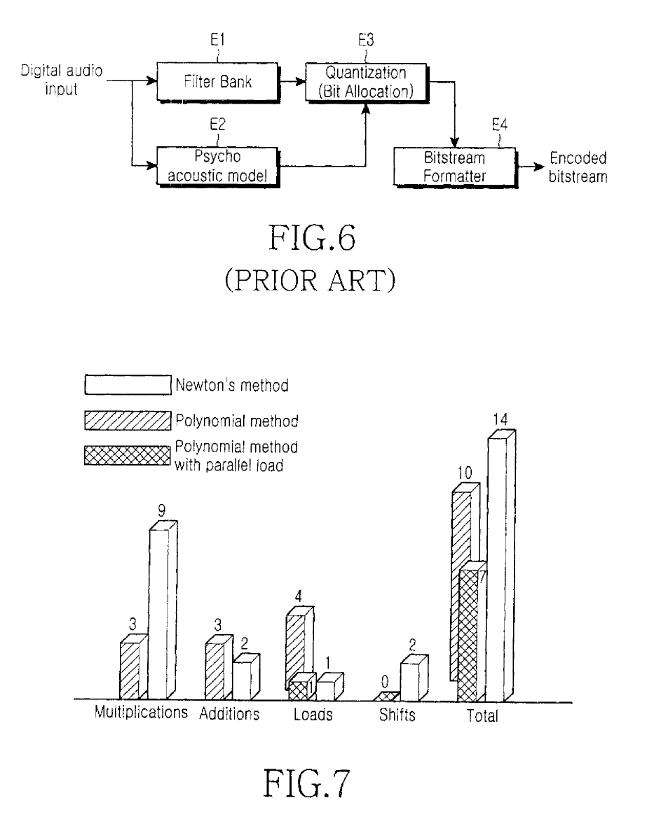

An apparatus and method for computing X^{-0.25} are illustrated in FIGS. 3, 4 and 5. FIG. 3 is a block diagram of a 0.75-power computing apparatus using Newton's repetition for comparison with the present invention and FIG. 5 is a flowchart illustrating a 0.75-power computing operation using Newton's repetition.

Referring to FIGS. 3 and 5, the Newton's −0.25-power computation apparatus includes a first multiplier N1 for squaring a predetermined initial guess value G according to the value of X (step 31), a second multiplier N2 for squaring the product received from the first multiplier N1 (step 32), a third multiplier N3 for multiplying the product received from the second multiplier N2 by the input signal X (step 33), a shifter N4 for shifting the product received from the third multiplier N3 two bits to the right (step 34) (divide by 4), an adder N5 for subtracting the shifted data received from the shifter N4 from a constant 5/4 (step 35), and a fourth multiplier N6 for multiplying the guess value G by the sum received from the adder N5 (step 36). The output of the fourth multiplier N6 is a new guess value for the next repetition.

The function blocks N1 to N6 repeat their operations using the new guess value. The resulting X^{-0.25} is multiplied by X, thus producing X^{0.75}.

In real-time system computation, guess values for use in the Newton's X^{-0.25} computation are preset. A maximum error involved in calculating the 0.75 power computation is 2 LSBs of 32 bits. A pseudo code for computing X^{-0.25} is given as
LOAD initial gues value G

i=0 to 2

Y=G×G

Y=Y×Y

Y=X×Y

Y=Y>>2

Y=5/4−Y

G=G×Y

and a pseudo code for computing X^{0.75} is given as

Y=X×G

The total number of cycles taken to compute a 0.75 power by Newton's approximation with two repetitions is 21 (i.e., 2×(4×2+1+1)+1).

As with the afore-described polynomial approximation, the range of an input signal X is 0.5≦X≦1 (i.e. 0x40000000 to 0x7FFFFFFF in Q31) in the Newton's approximation-based 0.75-power computation. In computing a −0.25-power, the range of the input signal X is divided into, for example, 64 areas and a guess value is preset for each area, hence 64 guess values in total. The 0.75-power computation by Newton's approximation suffers a maximum error equal to that of polynomial approximation and has a table size for guess values half the size of a table used for polynomial approximation. However, Newton's approximation requires 38 to 50% more cycles than the efficient polynomial approximation of the present invention.

Because 0.75-power computation is performed a number of times in encoding an audio signal, speed is more important than table size. In this respect, polynomial approximation outperforms Newton's repetition by 38 to 50%.

FIG. 7 is a graph comparing Newton's approximation, polynomial approximation, and polynomial approximation with parallel load in terms of a required number of arithmetic operations.

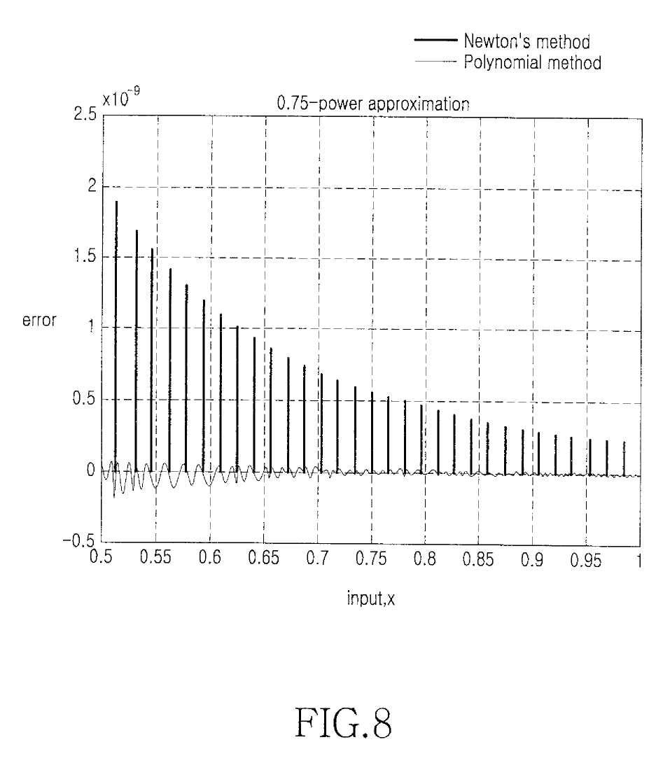

FIG. 8 is a graph illustrating comparing Newton's approximation, polynomial approximation, and polynomial approximation with parallel load in terms of errors involved in 0.75-power computation. For comparison purposes, an input is sampled to 32 areas in the Newton's method as the range of X is divided into 32 areas in the polynomial methods. FIG. 8 demonstrates that Newton's approximation causes more errors.

As is apparent from the above description, the 0.75-power computation method of the present invention is efficient and fast. Particularly, the present invention enables a DSP, especially a DSP without computation units that compute square roots/inverse square roots and reciprocals, to efficiently compute a 0.75-power. For example, polynomial approximation of the present invention outperforms Newton's repetition by 38 to 50%.

The above-described methods according to the present invention can be realized in hardware or as software or computer code that can be stored in a recording medium such as a CD ROM, an RAM, a floppy disk, a hard disk, or a magneto-optical disk or downloaded over a network, so that the methods described herein can be rendered in such software using a general purpose computer, or a special processor or in programmable or dedicated hardware, such as an ASIC or FPGA. As would be understood in the art, the computer, the processor or the programmable hardware include memory components, e.g., RAM, ROM, Flash, etc. that may store or receive software or computer code that when accessed and executed by the computer, processor or hardware implement the processing methods described herein.

While the invention has been shown and described with reference to certain exemplary embodiments of the present invention thereof, they are mere exemplary applications. For example, while a 3^{rd}-order polynomial is used as an approximation polynomial in the present invention, the approximation polynomial can be a 4^{th}-order polynomial. Thus, it will be understood by those skilled in the art that various changes in form and details may be made therein without departing from the spirit and scope of the present invention as defined by the appended claims and their equivalents.

What is claimed is:

1. A-power computation method operable in a computer system comprising:
dividing the range of an input value X into a predetermined number areas,
representing a 0.75 power of the input value X as a predetermined approximation polynomial, wherein coefficients for the approximation polynomial representing the input value X are preset for each of the areas; and
checking predetermined coefficients of the approximation polynomial for an actual input value X and computing a 0.75-power of the actual input value X using the approximation polynomial.

2. The method of claim 1, wherein the approximation polynomial is one of A×X³+B×X²+C×X+D and (((A×N+B)×X)+C)×X+D where A, B, C and D are the coefficients preset for each of the areas.

3. The method of claim 1, the range of the input value X is divided into 32 areas.

4. The method of claim 1, wherein the coefficients A, B, C and D can be preset to 0.088, −0.332, 1.155, and 0.089, respectively, for an input value X equal to 0.7.

5. A power computation apparatus for 0.75 power calculation, comprising:
a first multiplier for multiplying a coefficient A determined according to the input value X by the input value X and outputting a first product;
a first adder for adding a coefficient B determined according to the input value X to the first product and outputting a first sum;
a second multiplier for multiplying the first sum by the input signal X and outputting a second product;
a second adder for adding a coefficient C determined according to the input signal X by the second product and outputting a second sum;
a third multiplier for multiplying the second sum by the input signal X and outputting a third product; and
a third adder for adding a coefficient D determined according to the input signal X to the third product, wherein said coefficients are preset for each of a plurality of areas corresponding to ranges of input value X.

6. The apparatus of claim 5, wherein the range of input value X is divided into 32 areas.

7. The apparatus of claim 5, wherein the coefficients A, B, C and D can be preset to 0.088, −0.332, 1.155, and 0.089, respectively, for an input value X equal to 0.7.

8. An audio encoder for encoding an audio signal comprising;
means for multiplying a coefficient A determined according to the input value X by the input value X and outputting a first product;
means for adding a coefficient B determined according to the input value X to the first product and outputting a first sum;
means for multiplying the first sum by the input signal X and outputting a second product;
means for adding a coefficient C determined according to the input signal X by the second product and outputting a second sum;
means for multiplying the second sum by the input signal X and outputting a third product;
means for adding a coefficient D determined according to the input signal X to the third product, wherein said coefficients are preset for each of a plurality of areas corresponding to ranges of input value X; and
means for outputting said encoded audio signal.

9. The encoder of claim 8, wherein the range of input value X is divided into 32 areas.

10. The encoder of claim 8, wherein the coefficients A, B, C and D can be preset to 0.088, −0.332, 1.155, and 0.089, respectively, for an input value X equal to 0.7.

11. The method of claim 1, wherein the range of the input value X is divided uniformly distributed among the plurality of areas.

12. The method of claim 1 wherein the range of the input value X is divided non-uniformly distributed among the plurality of areas.

13. The method of claim 1 wherein the number of coefficients is determined by the order of the approximation polynomial.

14. The encoder of claim 8, wherein said means is software loaded into a DSP without units that calculate square roots/inverse square roots and reciprocals.

15. The encoder of claim 8, wherein said means comprises a plurality of multipliers and adders.

16. The encoder of claim 8, further comprising a memory, wherein said coefficients are stored in said memory.

17. The encoder of claim 16, wherein said means comprises a processor in communication with said memory.

18. The encoder of claim 17, wherein said processor accesses code stored in said memory.

19. The encoder of claim 18, wherein said code is provided to said memory on a computer-readable medium.

20. The encoder of claim 18, wherein said code is provided to said memory via an electronic transfer over a network.
